(19) United States
(12) Patent Application Publication
(10) Pub. No.: US 2013/0191113 A1
(43) Pub. Date: Jul. 25, 2013

(54) USER OPINION EXTRACTION METHOD USING SOCIAL NETWORK

(71) Applicants: Korea University Research and Business Foundat, Seoul (KR); Industry-University Cooperation Foundation Sogan, Seoul (KR)

(72) Inventors: Hoh Peter In, Seoul (KR); Youn Kyu Lee, Seoul (KR); Neung-Hoe Kim, Gyeonggi-do (KR); Dong-Min Seo, Seoul (KR)

(73) Assignees: Industry-University Cooperation Foundation Sogang University, Seoul (KR); KOREA UNIVERSITY RESEARCH AND BUSINESS FOUNDATION, Seoul (KR)

(21) Appl. No.: 13/678,667

(22) Filed: Nov. 16, 2012

(30) Foreign Application Priority Data
Nov. 18, 2011 (KR) 10-2011-0121082

(51) Int. Cl. G06F 17/28

(52) U.S. Cl. CPC G06F 17/28
USPC 704/9

(57) ABSTRACT

A user opinion extraction method that includes: searching for social network groups that respectively have made one or more connections to a site having a domain that relates to software to be developed using a search module; analyzing structures of social networks for the retrieved social network groups using an analysis module; selecting a social network group from which user opinions are to be extracted based on a result of the analysis and collecting user opinions from SNS sentences that are mutually transmitted and received between a plurality of nodes within the selected social network group using a collection module; calculating degrees of influences of the collected user opinions on the social network group using a calculation module; and extracting at least one user opinion from among the collected user opinions in order of a higher degree of the influence on the social network group using an extraction module.

### TECHNICAL FIELD

The following disclosure relates to a user opinion extraction method using a social network, and in particular, to a user opinion extraction method using a social network in which a group using a social network is selected, and user opinions are extracted from SNS sentences that are transmitted and received between nodes within the group.

### BACKGROUND

In accordance with high-speed development of technologies, various user opinions are practically reflected in all the fields. Such user opinions are represented as needs, and user-oriented software on which user needs are reflected is produced in a variety of fields.

Accordingly, in producing software, it may be stated that success of the software depends on whether or not user opinions, in other words, user needs are specifically acquired in detail.

In order to acquire such user needs, a survey method such as a telephone survey in which opinions are collected in a wired manner by calling users, a questionnaire survey in which users are directly called on, and a questionnaire is presented so as to directly receive opinions, an online survey in which a specific site for a survey is connected, and the survey is carried out, or the like may be used. However, according to such a survey method, since it is necessary to directly contact users or to lead users to respond to a survey, there is a psychological burden on the users, and there are problems in that user's time needs to be spent, and the cost for the survey is high.

In addition, since a direct survey is carried out for users, in order to extract user needs, in other words, user opinions with higher accuracy, there is a problem in that the range of the survey is very limited.

As described above, related arts that relate to a user opinion extraction methods using a social network are as follows.

In related art disclosed in Korean Patent Application Laid-Open No. 2011-0022518 (Mar. 7, 2011), a product purchasing service providing device using a social network and a method thereof are disclosed. In the related art, a method is disclosed which is used for purchasing a product that is appropriate for a purchaser through participants participating to a social network that have the same taste or hobby. According to the method, opinions from persons having similar tastes or persons known in advance are requested in real-time based on a social network, a result of the responses thereto are acquired, the degree of reliability for each opinion provider is applied thereto, and the result is updated, maintained, and managed, whereby a social shopping service having higher reliability can be provided.

In addition, in related art disclosed in Korean Patent Application Laid-Open No. 2011-0080302 (Jul. 13, 2011), a method is disclosed in which personal network competitiveness on an online social network and a network effect are measured. According to the related art, a social network is implemented online, and, by analyzing the network, the competitiveness of each person, a network effect, network competitiveness, a social rank, and the like at the time of providing a social networking service (SNS) are quantificated, and information values are assigned to nodes and ties of the network.

### SUMMARY

An embodiment of the present disclosure is directed to providing a user opinion extraction method using a social network that is capable of easily extracting user opinions from SNS sentences transmitted and received between nodes within a social network group after selecting the social network group relating to a domain that relates to software to be developed from among social network groups.

In one general aspect, a user opinion extraction method using a social network includes: searching for social network groups that respectively have made one or more connections to a site having a domain that relates to software to be developed by using a search module; analyzing structures of social networks for the retrieved social network groups by using an analysis module; selecting a social network group from which user opinions are to be extracted based on a result of the analysis and collecting user opinions from SNS sentences that are mutually transmitted and received between a plurality of nodes within the selected social network group by using a collection module; calculating degrees of influences of the collected user opinions on the social network group by using a calculation module; and extracting at least one user opinion from among the collected user opinions in order of a higher degree of the influence on the social network group by using an extraction module.

In the aspect described above, the method may further include: analyzing the degree of network binding or a connection maintaining time between nodes within the retrieved social network group using the analysis module.

In the aspect described above, the selecting of a social network group and collecting of user opinions may further include transmitting a subject relating to the software for which user opinions are to be collected to nodes within the selected social network group and receiving responses for the transmitted subject from the nodes by using the collection module.

In the aspect described above, the selecting of a social network group and collecting of user opinions may further include generating a keyword relating to the domain, checking whether or not an SNS sentence including the keyword is transmitted and received between nodes within the selected social network group, and then receiving the SNS sentence including the keyword by using the collection module.

In a user opinion extracting method using a social network according to the present disclosure, by extracting user opinions used for being applied to the software to be developed from SNS sentences transmitted and received between nodes within a social network group, the user opinions can be extracted in a very easy manner not through an additional device or process. Accordingly, there is an advantage of reducing the time and the cost for extracting the user opinions.

In addition, in the user opinion extracting method using a social network according to the present disclosure, by extracting user opinions from SNS sentences that are exchanged through the social network, the range of research for extracting the user opinions is very wide, and there is an advantage of extracting user opinions that are more accurate and specific. Accordingly, the software on which accurate user opinions are reflected can be developed, and there is an advantage of improving the degree of completeness of the development of the software.

Furthermore, in the user opinion extraction method using a social network according to the present disclosure, after at least one user opinion is collected from SNS sentences that are exchanged through the social network and the degrees of the influence of the collected user opinions on the social network are calculated, the user opinions are extracted in order of a higher degree of the influence and are applied to the software to be developed, whereby there is an advantage of extracting more objective user opinions.

### BRIEF DESCRIPTION OF THE DRAWINGS

The above and other objects, features and advantages of the present disclosure will become apparent from the following description of certain exemplary embodiments given in conjunction with the accompanying drawing, in which:

FIG. 1 is a flowchart of a user opinion extraction method, which uses a social network, according to an embodiment of the present disclosure.

### DETAILED DESCRIPTION OF EMBODIMENTS

Hereinafter, the present disclosure will be described in detail so as to be easily performed by a person having ordinary knowledge in a technical field to which the present disclosure belongs based on a preferred embodiment with reference to the accompanying drawings. However, the present disclosure may be implemented in various different forms and is not limited to the embodiment described here.

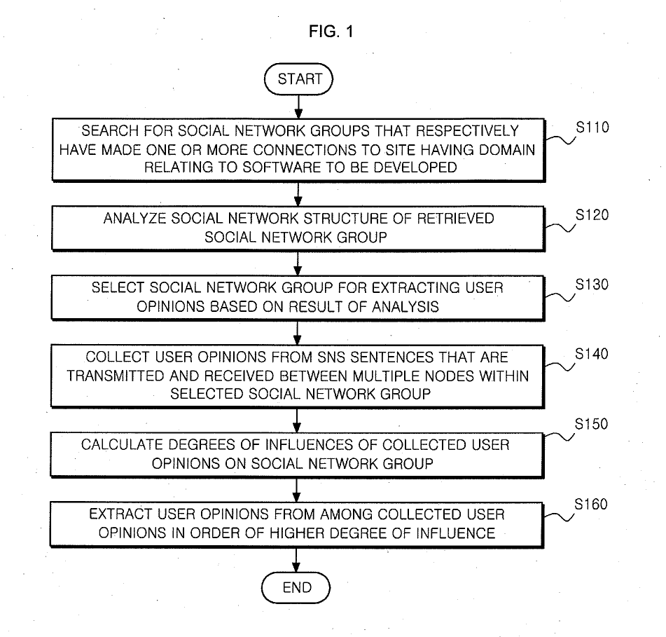

Hereinafter, a user opinion extraction method using a social network according to the present disclosure will be described in detail with reference to FIG. 1.

FIG. 1 is a flowchart of a user opinion extraction method, which uses a social network, according to an embodiment of the present disclosure.

As illustrated in FIG. 1, according to the user opinion extraction method using a social network of the present disclosure, first, a search module searches for a social network group that has made one or more connections to a web site having a domain relating to software to be developed (S110). At this time, the used social network service (SNS) represents a social relation structure that is formed by mutual dependency relation between nodes each formed by a person or a group on the web. All the nodes within the social network are individual subjects existing within the network. Examples of such a social network include Twitter, Facebook, me2day, Blog, MySpace, and Foursquare.

As above, the retrieved social network group represents a group in which multiple nodes are interconnected through the above-described social network, and the above-described social network group represents a social network group that has made at least one or more connections to the site having the above-described domain and is determined to have close relation with the software to be developed, for example, by having preference for the site having the above-described domain.

Accordingly, an analysis module analyzes the network structure of the social network group that is retrieved in S110 in advance (S120). Described in more detail, the analysis module analyzes mutual binding information between nodes, a connection maintaining time in which a connection is made to the social network group between the nodes, or the like for multiple nodes that are included in the social network group. In addition, the analysis module may further analyze the centrality of the social network group for each node, the density of nodes within the social network group, the inclusiveness of the social network, and the like.

As described above, a collection module selects a social network group from which user opinions are extracted based on an analysis result acquired by analyzing the network structure within the retrieved social network group (S130). In other words, from among social network groups that have made one or more connections to a site having a domain relating to the software to be developed and is determined to be interested in the software, a social network group that has a highest mutual binding force between nodes within the social network group or having a longest connection maintaining time is selected as a social network group from which user opinions are to be extracted based on the analysis result that is acquired through analysis performed in S120 in advance.

Thereafter, SNS sentences that are transmitted and received between multiple nodes included in the social network group that is selected by the collection module are received, and user opinions are collected from the received SNS sentences (S140). When the operation of collecting user opinions is described in detail, first, a subject relating to software to be developed is selected by the collection module, and the selected subject is transmitted to each node within the social network group that is selected in S130 in advance. Accordingly, the collection module receives various responses relating to the transmitted subject from each node within the social network group.

Alternatively, the collection module may generate at least one keyword that relates to a domain relating to the software to be developed, check whether each SNS sentence transmitted and received between nodes within the social network group selected in S130 in advance includes the keyword, and receive SNS sentences that include the keyword from each node.

Thereafter, a calculation module calculates the degrees of influences of the user opinions, which are collected in operation S140 in advance, on the social network group (S150). It is preferable that the operation of calculating the degrees of influence is individually calculated for each user opinion.

Hereinafter, the operation of calculating the degree of influence of the user opinion will be described in detail by referring to Mathematical Equation 1.

$${Impact}_{req} = \sum ( {C}_{n} \times {D}_{g} ) \times \frac{{F}_{req} \times {I}_{g}}{{Num}_{g}} \qquad Mathematical Equation 1$$

Here, Cₙ represents the centrality according to the network structure of the social network group from which the user opinions are collected, D_{g} represents the density of the social network group from which the user opinions are collected, F_{req} represents the occurrence frequency of the user opinion, I_{g} represents the inclusiveness of the social network group, and Num_{g} represents a total number of opinions within the social network group.

As represented in Mathematical Equation 1, after the centrality Cₙ according to the network structure of the social network group is multiplied by the density D_{g} of the social network group, resultant values for each node included within the social network group are added together. In addition, a value acquired by multiplying the occurrence frequency F_{req} of the user opinion by the inclusiveness I_{g} of the social network group is divided by the total number Num_{g} of the opinions included in the social network group, and a resultant value is multiplied by the value acquired in advance by multiplying the centrality Cₙ according to the network structure of the social network group by the density D_{g} of the social network group and adding resultant values for each node included in the social network group, whereby the degree of influence of a specific user opinion on the social network group can be calculated.

In addition, a verification operation may be further performed for the result of the calculation of the degree of influence on the social network group for the specific user opinion as described above. For the additional verification operation, the result of the calculation of the degree of influence may be verified using a Kendall's coefficient of concordance technique. The Kendall's coefficient of concordance is an index that represents the degree of mutual concordance of rated results represented to have the same rank for the same target by K raters and is used for acquiring correlation between variables in a case where the number of the variables formed by the ranking scale is three or more.

As described above, after the degrees of influences of user opinions are calculated, and the calculation results are verified, an extraction module arranges the calculation results of the degrees of influences in the descending order and extracts high-ranked n user opinions corresponding to the number set in advance as initial user opinions to be applied for the development of the software (S160).

As above, by applying the extracted initial user opinions to the development of the software, the user-oriented software that matches the user opinions can be produced, whereby the degree of user satisfaction can be improved.

In the user opinion extraction method using a social network according to the present disclosure, a computer-readable recoding medium includes any type of recording device in which data that can be read by a computer system is stored. Examples of the computer-readable recording device include a ROM, a RAM, a CD-ROM, a DVD±ROM, a DVD-RAM, a magnetic tape, a floppy disk, a hard disk, and an optical data storing device. In addition, the recording medium that can be read by a computer may be distributed to another computer apparatus that is connected through a network, and a computer-readable code may be stored and executed in a distributed manner.

In the user opinion extracting method using a social network according to the present disclosure, by extracting user opinions used for being applied to the software to be developed from SNS sentences transmitted and received between nodes within a social network group, the user opinions can be extracted in a very easy manner not through an additional device or process. Accordingly, there is an advantage of reducing the time and the cost for extracting the user opinions.

In addition, in the user opinion extracting method using a social network according to the present disclosure, by extracting user opinions from SNS sentences that are exchanged through the social network, the range of research for extracting the user opinions is very wide, and there is an advantage of extracting user opinions that are more accurate and specific. Accordingly, the software on which accurate user opinions are reflected can be developed; and there is an advantage of improving the degree of completeness of the development of the software.

Furthermore, in the user opinion extraction method using a social network according to the present disclosure, after at least one user opinion is collected from SNS sentences that are exchanged through the social network and the degrees of the influence of the collected user opinions on the social network are calculated, the user opinions are extracted in order of a higher degree of the influence and are applied to the software to be developed, whereby there is an advantage of extracting more objective user opinions.

While the present disclosure has been described with respect to the specific embodiments, it will be apparent to those skilled in the art that various changes and modifications may be made without departing from the spirit and scope of the disclosure as defined in the following claims.

1. A user opinion extraction method using a social network, the method comprising:
searching for social network groups that respectively have made one or more connections to a site having a domain that relates to software to be developed by using a search module;
analyzing structures of social networks for the retrieved social network groups by using an analysis module;
selecting a social network group from which user opinions are to be extracted based on a result of the analysis and collecting user opinions from SNS sentences that are mutually transmitted and received between a plurality of nodes within the selected social network group by using a collection module;
calculating degrees of influences of the collected user opinions on the social network group by using a calculation module; and
extracting at least one user opinion from among the collected user opinions in order of a higher degree of the influence on the social network group by using an extraction module.

2. The user opinion extraction method using a social network according to 1, wherein, in said analyzing of structures of social networks, the analysis module analyzes the degree of network binding or a connection maintaining time between nodes within the retrieved social network group.

3. The user opinion extraction method using a social network according to 1, wherein said selecting of a social network group and collecting of user opinions further includes transmitting a subject relating to the software for which user opinions are to be collected to nodes within the selected social network group and receiving responses for the transmitted subject from the nodes by using the collection module.

4. The user opinion extraction method using a social network according to 1, wherein said selecting of a social network group and collecting of user opinions further includes generating a keyword relating to the domain, checking whether or not an SNS sentence including the keyword is transmitted and received between nodes within the selected social network group, and then receiving the SNS sentence including the keyword by using the collection module.

5. A computer-readable recording medium on which a program for performing the method according to claim 1 using a computer is recorded.
